(19) United States
(12) Patent Application Publication
(10) Pub. No.: US 2026/0330704 A1
(43) Pub. Date: Oct. 22, 2026

(54) DIFFUSION TRANSFORMER DISTILLATION

(71) Applicant: ADOBE INC., SAN JOSE, CA (US)

(72) Inventors: Zhonghao Wang, San Jose, CA (US); Kai Zhang, San Jose, CA (US); Abdullah Rashwan, San Jose, CA (US)

(21) Appl. No.: 19/377,147

(22) Filed: Nov. 3, 2025

Related U.S. Application Data
(60) Provisional application No. 63/792,529, filed on Apr. 22, 2025.

(51) Int. Cl. G06T 11/00; G06V 10/764; G06V 10/774; G06V 10/82

(52) U.S. Cl. CPC G06T 11/00; G06V 10/764; G06V 10/774; G06V 10/82

(57) ABSTRACT

A method, apparatus, non-transitory computer readable medium, and system for distilling an image generation model begins with obtaining a teacher model trained to generate synthetic images. Embodiments then compute a distribution matching distillation (DMD) loss for an image generation model using the teacher model. Next, using a discriminator model, embodiments compute a generative adversarial network (GAN) loss for the image generation model. The discriminator model classifies an output of the image generation model. Embodiments then train the image generation model to generate synthetic images using the distribution matching loss and the GAN loss.

### CROSS-REFERENCE TO RELATED APPLICATION

This U.S. non-provisional application claims priority under 35 U.S.C. § 119 to U.S. Provisional Patent Application No. 63/792,529, filed on Apr. 22, 2025, in the United States Patent and Trademark Office, the disclosure of which is incorporated by reference herein in its entirety.

### BACKGROUND

The following relates generally to image processing, and more specifically to image generation. Image processing is a type of data processing that involves the manipulation of an image to get the desired output, typically utilizing specialized algorithms and techniques. It is a method used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Image processing techniques are also used for image generation. For example, machine learning (ML) techniques have been applied to create generative models that can produce new image content. One use for generative AI is to create images based on an input prompt. This task is often referred to as a “text to image” task or simply “text2img”. Some models such as GANs and Variational Autoencoders (VAEs) employ an encoder-decoder architecture with attention mechanisms to align various parts of text with image features. Newer approaches such as denoising diffusion probabilistic models (DDPMs) iteratively refine generated images in response to textual prompts. There has been continued research into developing generative models capable of faster inference speeds and higher resolutions.

### SUMMARY

Embodiments of the present disclosure include systems and methods for generating images and other media such as videos with increased speed. Embodiments include an image generation model that is configured during a training process, where the training process is based on outputs from a teacher model. During a training phase, the teacher model with locked parameters computes a score function from a noised output of the student model, and an auxiliary model that is jointly trained with the image generation model also computes a score function. The teacher score function and the auxiliary score function are combined into a gradient term that is used to guide the student image generation model to match the distribution (e.g. set of possible outputs) from the teacher model. Some embodiments further incorporate a GAN loss to train the image generation model. The GAN loss is generated by a discriminator work that is also jointly trained with the image generation model. The discriminator model is a classifier that aims to accurately predict whether its input is a synthetic (“fake”) image generated by the image generation model, or a real image from a set of real images. Further still, some embodiments incorporate an ordinary differential equation (ODE) matching loss that acts as a regularizer during training, as well as to align the denoising trajectory of the image generation model with that of the teacher model. There are various possible implementations to computing the ODE matching loss. Some embodiments utilize a set of noise-image pairs, where the noise in the pair is a noise sample from a noise distribution and the image in the pair is an output image from the teacher model as generated from the noise sample. At the end of training, the image generation model is configured to generate images in much fewer steps than the teacher model (e.g., 1-4 vs. the teacher's 50 to 1000 steps) and may output even higher quality images than the teacher model.

Some embodiments employ a hybrid sampling scheme. Embodiments may utilize the teacher model during a first inference phase, and then the trained student model (the image generation model) in a second inference phase. For example, embodiments may denoise a noise input for a predetermined number of diffusion timesteps using the teacher model to obtain an intermediate denoised image, and then denoise the intermediate denoised image using the image generation model to generate a synthetic image. According to some aspects, this balances quality and accuracy from the teacher model with the inference efficiency of the student model.

Some embodiments utilize a U-Net diffusion transformer (UDiT) architecture for the image generation model, the teacher model, the discriminator model, or some combination thereof. The UDiT borrows structures from a U-Net model and a DiT model. The U-Net model incorporates convolutional layers, downsampling layers, upsampling layers, and skip connections, and is a popular model for various tasks including classification, feature generation, and denoising diffusion operations. The DiT model uses a transformer backbone and includes a series of DiT blocks configured to process tokens with attention operations. The DiT model may also be used for denoising diffusion. The UDiT model similarly processes tokens but includes downsampling and upsampling layers to reduce the number of tokens for middle DiT blocks (while increasing their embedding dimension). This increases the efficiency of inference due to the quadratic nature of attention operations.

A method, apparatus, non-transitory computer readable medium, and system for image generation are described. One or more aspects of the method, apparatus, non-transitory computer readable medium, and system include obtaining a teacher model trained to generate synthetic images; computing a distribution matching loss for the image generation model using the teacher model; computing a GAN loss for the image generation model using a discriminator model, wherein the discriminator model classifies an output of the image generation model; and training the image generation model to generate synthetic images using the distribution matching loss and the GAN loss.

A method, apparatus, non-transitory computer readable medium, and system for image generation are described. One or more aspects of the method, apparatus, non-transitory computer readable medium, and system include obtaining an input prompt; generating, using a teacher model, an intermediate denoising output based on the input prompt; and generating, using an image generation model, a synthetic image based on the intermediate denoising output.

A method, apparatus, non-transitory computer readable medium, and system for image generation are described. One or more aspects of the method, apparatus, non-transitory computer readable medium, and system include obtaining an input prompt; generating, using a first transformer block of an image generation model, a first set of intermediate tokens having a first patch size based on the input prompt; generating, using a second transformer block of the image generation model, a second set of intermediate tokens having a second patch size based on the first set of intermediate tokens; and generating, using the image generation model, a synthetic image based on the second set of intermediate tokens.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of a guided latent diffusion model according to aspects of the present disclosure.

FIG. 4 shows an example of a Transformer architecture according to aspects of the present disclosure.

FIG. 5 shows an example of a U-Net architecture according to aspects of the present disclosure.

FIG. 6 shows an example of a diffusion transformer (DiT) architecture according to aspects of the present disclosure.

FIG. 7 shows an example of a U-Net diffusion transformer (UDiT) architecture according to aspects of the present disclosure.

FIG. 8 shows an example of a training pipeline according to aspects of the present disclosure.

FIG. 9 shows an example of a step-by-step training algorithm according to aspects of the present disclosure.

FIG. 10 shows an example of a method for training diffusion models according to aspects of the present disclosure.

FIG. 11 shows an example of a diffusion process according to aspects of the present disclosure.

FIG. 12 shows an example of a computing device according to aspects of the present disclosure.

FIG. 13 shows an example of a method for training a machine learning model according to aspects of the present disclosure.

### DETAILED DESCRIPTION

Image processing techniques, such as image generation, are frequently used in creative workflows. Historically, users would rely on manual techniques and drawing software to create visual content. The advent of machine learning (ML) has enabled new workflows that automate the image creation process. These ML-based workflows can significantly reduce the time and technical expertise required to produce complex visual content, allowing creators to focus more on ideation and less on manual execution.

ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention.

Image generation models use ML techniques to create new images based on various inputs. Recent advancements in diffusion models have enabled high-quality image synthesis from text descriptions. These models learn to gradually denoise random patterns into coherent images that match input prompts. The quality and realism of generated images has improved dramatically. These advancements have enabled new applications in creative industries, entertainment, and design.

Embodiments of the disclosure use a machine learning technique known as knowledge distillation. Knowledge distillation is a training technique that enables the transfer of learned representations and capabilities from one model to another. For example, training may be transferred from a larger, more complex “teacher” model to a smaller, more efficient “student” model. This process allows the creation of compact models that retain much of the performance of their larger counterparts while offering significant computational advantages during inference. Knowledge distillation is particularly valuable in scenarios where computational resources are limited or where faster inference times are required without substantial loss of model performance.

In some knowledge distillation frameworks, the teacher model is a pre-trained, high-capacity neural network that has already achieved strong performance on a given task. The teacher model is used as a source of rich, learned representations that encode complex patterns and relationships within the data. These representations often contain more nuanced information than what can be captured by simple ground-truth labels alone. The student model, conversely, is typically a smaller architecture designed for efficiency, featuring fewer parameters, reduced computational complexity, or alternative architectural components that enable faster processing.

Some conventional methods for distilling diffusion models focus on training student generators using adversarial objectives, where a discriminator network attempts to distinguish between real images and generated samples. While these generative adversarial network (GAN) based techniques can produce visually appealing results, they often suffer from training instability and mode collapse, where the generator fails to capture the full diversity of the target distribution. Further, a GAN loss alone does not provide sufficient signal to effectively compare student and teacher model outputs, which limits the quality of knowledge transfer from the pre-trained diffusion model.

Other conventional techniques use distribution matching methods that attempt to align the output distributions of student and teacher models by minimizing divergences such as the Kullback-Leibler divergence. However, these methods typically require computationally expensive regression losses calculated using large datasets of noise-image pairs generated by running the full sampling steps of the teacher model. This requirement not only increases training costs significantly for large-scale text-to-image synthesis but can also set a limit the student model's potential quality.

Distribution Matching Distillation (DMD) is a form of knowledge distillation particularly suited for generative models, including diffusion models used for image generation. DMD addresses a specific challenge in generative modeling: while traditional knowledge distillation might focus on matching individual outputs, DMD ensures that the entire distribution of generated samples from the student model closely matches the distribution produced by the teacher model. This approach is useful for generative tasks where maintaining the overall quality and diversity of generated content is as important as achieving good performance on individual samples.

In DMD, the main objective involves minimizing a divergence metric, such as Kullback-Leibler (KL) divergence, between the teacher's output distribution and the student's output distribution. This process may include estimating and comparing the score functions of these distributions, which represent the gradients of the log-probability density functions. By aligning these distributions, DMD ensures that the student model not only produces high-quality individual samples but also maintains the same overall generative capabilities as the teacher, including the ability to produce diverse outputs that span the same regions of the data manifold. As with many machine learning formulations, however, differences in implementation affect model size, training stability, and inference species. In other words, there are different ways to implement minimizing divergence metrics.

Embodiments of the present disclosure improve the speed, fidelity, and training stability of student image generation models with the combination of a distribution matching distillation (DMD) loss and a generative adversarial network (GAN) loss. This combination of losses increases the speed of convergence during training and enables the student model to surpass the teacher model in accuracy and fidelity metrics. Further, embodiments train a U-Net diffusion transformer (U-DiT)-based student model, which increases inference speed over conventional diffusion transformer models by processing fewer tokens during generation.

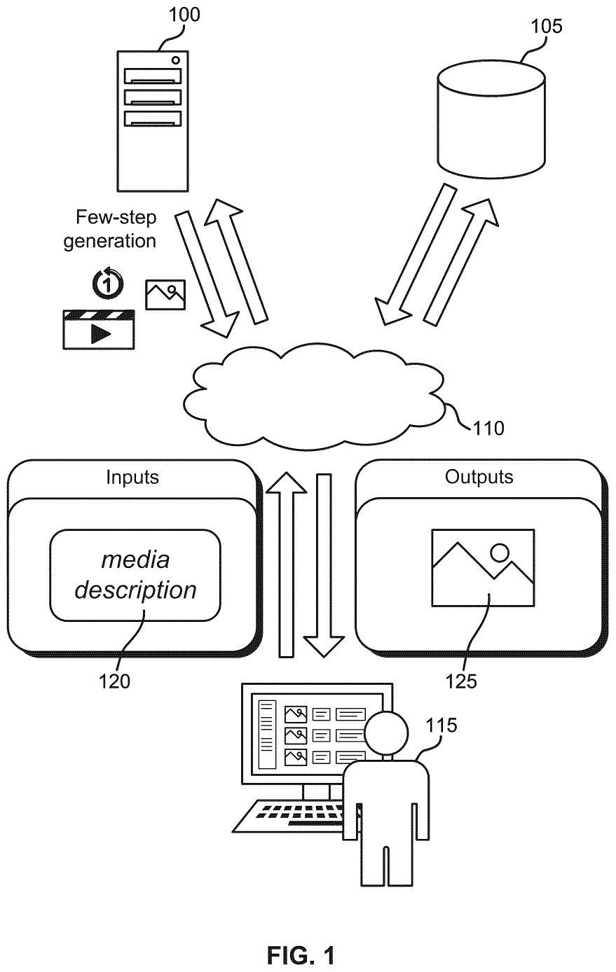

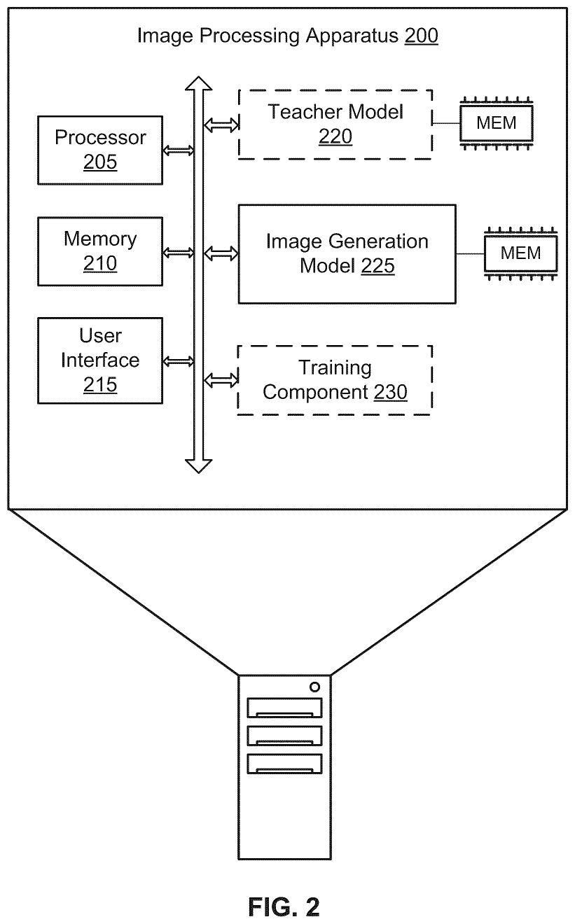

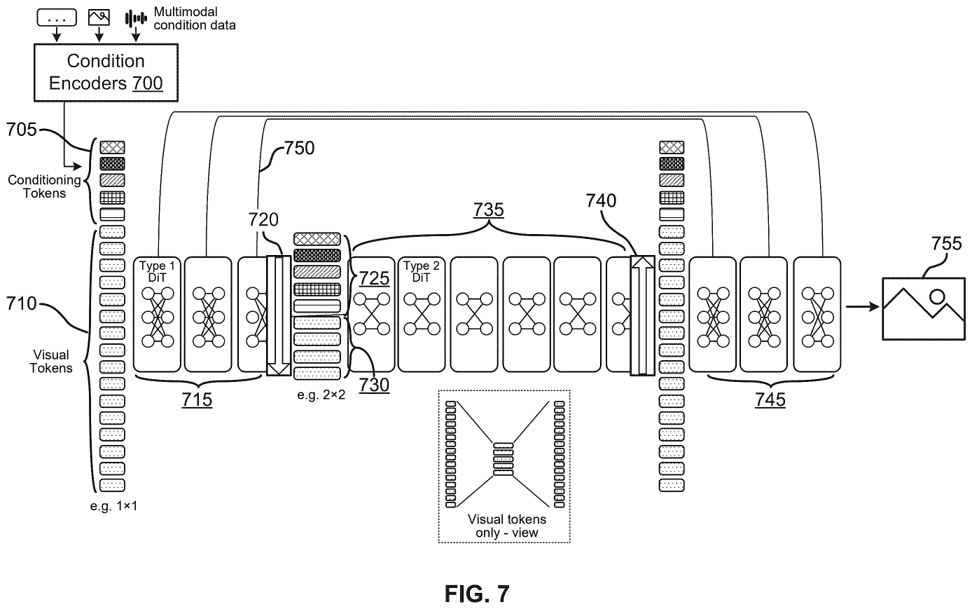

FIG. 1 shows an example of an image processing system according to aspects of the present disclosure. The example shown includes image processing apparatus 100, database 105, network 110, user 115, input prompt 120, and synthetic image 125. Image processing apparatus 100 is an example of, or includes aspects of, the corresponding element described with reference to FIG. 2. Synthetic image 125 is an example of, or includes aspects of, the corresponding element described with reference to FIG. 7.

In an example process, user 115 provides input prompt 120 which describes an image the user wishes to generate. The image processing apparatus 100 then generates synthetic image 125 using an embedding of the input prompt 120 as a guidance signal. The system then provides synthetic image 125 back to user 115 for, e.g., approval or further editing. The image processing apparatus 100 may generate the output in greatly reduced time as compared to conventional image processing systems. For example, in some embodiments, the system may generate the image in less than a second.

In some embodiments, one or more components of image processing apparatus 100 are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

Database 105 is configured to store information used by the image processing system. For example, database 105 may store model parameters, generated images, generated videos, intermediate representations and embeddings, user configuration settings, activity history, model training data, and the like. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with the database controller. In other cases, the database controller may operate automatically without user interaction.

Network 110 facilitates the transfer of information between image processing apparatus 100, database 105, and user 115. In some cases, network 110 is referred to as a “cloud”. A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of an image processing apparatus 200 according to aspects of the present disclosure. The example shown includes image processing apparatus 200, processor 205, memory 210, user interface 215, teacher model 220, image generation model 225, and training component 230. Image processing apparatus 200 is an example of, or includes aspects of, the corresponding element described with reference to FIG. 1.

A processor 205 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor 205 is configured to operate a memory array using a memory controller. In other cases, a memory controller is integrated into processor 205. In some cases, processor 205 is configured to execute computer-readable instructions stored in memory 210 to perform various functions. In some embodiments, processor 205 includes special purpose components for modem processing, baseband processing, digital signal processing, or transmission processing.

Memory 210 stores information used in the operation of image processing apparatus 200. Examples of a memory device include random access memory (RAM), read-only memory (ROM), or a hard disk. Examples of memory devices include solid state memory and hard disk drives. In some examples, memory 210 is used to store computer-readable, computer-executable software including instructions that, when executed, cause processor 205 to perform various functions described herein. In some cases, the memory 210 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 210 store information in the form of a logical state.

According to some aspects, some components of the image processing apparatus 200 may include dedicated memories as indicated by the ‘MEM’ elements in FIG. 2. These dedicated memories may store model parameters that, when combined with mathematical operations executed by processor 205, cause the corresponding components to perform the functions described herein. In some embodiments, the dedicated memories are implemented as non-transitory computer-readable mediums. The parameters may be stored statically or configured at runtime. For example, adjustments to the parameters may be made during pretraining processes, finetuning processes, or user-configuration processes such as hot-swapping different models. In certain implementations, these specialized memory structures enable hardware-accelerated execution of complex computational functions through purpose-built circuitry optimized for specific operations, thereby transforming the general-purpose computing device into a specialized machine uniquely configured to perform the particular image processing operations described herein. The dedicated memories may be coupled with specialized processing units, such as tensor processing units or neural processing units, which implement custom data paths specifically designed to execute the mathematical operations required by the image processing components.

A user interface 215 enables a user to interact with image processing apparatus 200. In some embodiments, user interface 215 includes an audio device, such as an external speaker system, an external display device such as a display screen, or an input device (e.g., remote control device interfaced with the user interface 215 directly or through an IO controller module). In some cases, user interface 215 includes a graphical user interface (GUI).

Teacher model 220 is configured to generate media, such as images, similar to image generation model 225. Teacher model 220 may be configured to use more compute than image generation model 225 to generate an output. For example, embodiments of teacher model 220 may generate images with a denoising schedule that includes many denoising iterations, e.g., 50. Teacher model 220 generates outputs such as a score, a noise prediction, or intermediate features that are used to guide the training of image generation model 225.

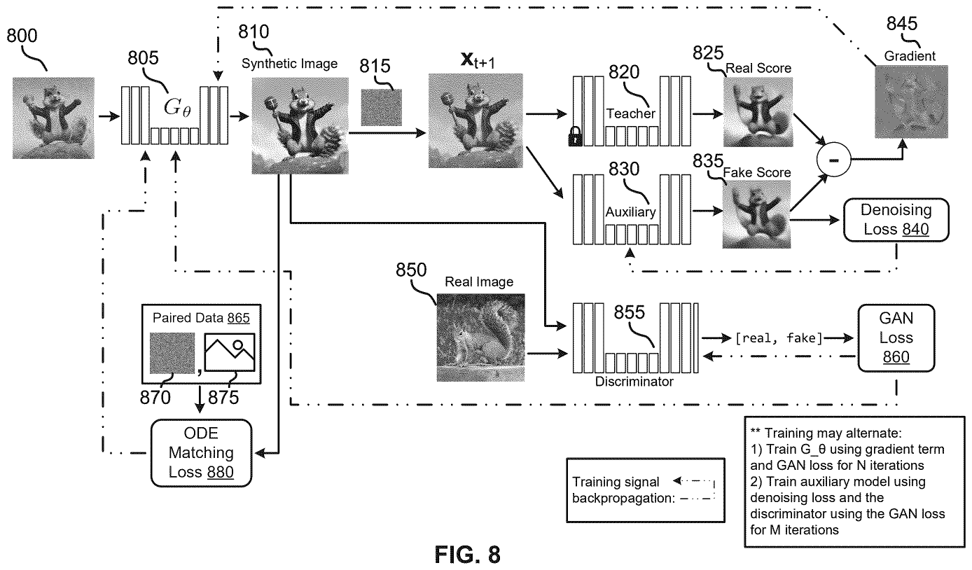

According to some aspects, teacher model 220 computes a distribution matching loss for the image generation model 225 using the teacher model 220. In some examples, teacher model 220 computes a first score function for an image generation model 225 using the teacher model 220. Teacher model 220 is an example of, or includes aspects of, the corresponding element described with reference to FIG. 8.

Image generation model 225 is configured to generate media, such as images, using less compute than teacher model 220. For example, image generation model 225 may be configured to generate images in as few as 1-4 iterations. In some aspects, the image generation model 225 includes a U-Net diffusion transformer (UDiT).

According to some aspects, image generation model 225 generates a synthetic image based on the intermediate denoising output. In some aspects, the intermediate denoising output is generated using a first denoising phase including a first set of denoising timesteps, and the synthetic image is generated using a second denoising phase including a second set of denoising timesteps following the first set of denoising timesteps. In some aspects, the image generation model 225 includes a U-Net diffusion transformer (UDiT).

According to some aspects, image generation model 225 generates, using a first transformer block of an image generation model 225, a first set of intermediate tokens having a first patch size based on the input prompt. In some examples, image generation model 225 generates, using a second transformer block of the image generation model 225, a second set of intermediate tokens having a second patch size based on the first set of intermediate tokens. In some examples, image generation model 225 generates a synthetic image based on the second set of intermediate tokens. In some examples, image generation model 225 obtains a set of noise tokens having the first patch size, where the first set of intermediate tokens are generated based on the set of noise tokens.

In some examples, image generation model 225 generates a set of conditioning tokens, where the first set of intermediate tokens are generated based on the set of conditioning tokens. In some examples, image generation model 225 generates, using a third transformer block of the image generation model 225, a third set of intermediate tokens having the first patch size based on the second set of intermediate tokens, where the synthetic image is generated based on the third set of intermediate tokens. In some examples, image generation model 225 provides the first set of intermediate tokens to the third transformer block via a skip connection. In some examples, image generation model 225 compresses the first set of intermediate tokens to obtain a set of compressed tokens having the second patch size, where the second set of intermediate tokens are based on the set of compressed tokens. In some aspects, the second set of intermediate tokens includes a higher number of embedding dimensions than the first set of intermediate tokens. In some aspects, the second set of intermediate tokens includes fewer tokens that the first set of intermediate tokens. In some aspects, the image generation model 225 includes a U-Net diffusion transformer (UDiT). Image generation model 225 is an example of, or includes aspects of, the corresponding element described with reference to FIG. 8.

Training component 230 is configured to update parameters of image generation model 225 during one or more training phases. For example, training component 230 is configured to compute one or more loss functions based on outputs of teacher model 220 and image generation model 225, and backpropagate the losses to update the parameters of image generation model 225 according to a training algorithm such as gradient decent. According to some aspects, training component 230 trains the image generation model 225 to generate synthetic images using the distribution matching loss and the GAN loss. In some examples, training component 230 computes a Kullback-Leibler (KL) divergence based on the first score function and the second score function. In some examples, training component 230 computes an ODE matching loss, where the image generation model 225 is trained based on the ODE matching loss.

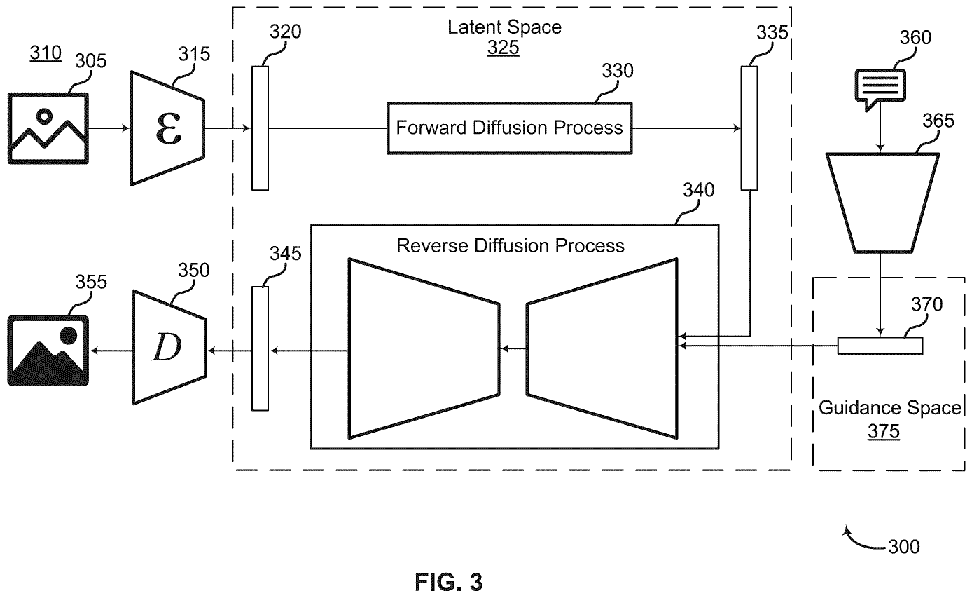

FIG. 3 shows an example of a guided latent diffusion model 300 according to aspects of the present disclosure. The guided latent diffusion model 300 depicted in FIG. 3 is an example of, or includes aspects of, the image generation model 225 described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 300 may take an original image 305 in a pixel space 310 as input and apply and image encoder 315 to convert original image 305 into original image features 320 in a latent space 325. Then, a forward diffusion process 330 gradually adds noise to the original image features 320 to obtain noisy features 335 (also in latent space 325) at various noise levels.

Next, a reverse diffusion process 340 (e.g., a U-Net ANN or a diffusion transformer (DiT) ANN) gradually removes the noise from the noisy features 335 at the various noise levels to obtain denoised image features 345 in latent space 325. In some examples, the denoised image features 345 are compared to the original image features 320 at each of the various noise levels, and parameters of the reverse diffusion process 340 of the diffusion model are updated based on the comparison. Finally, an image decoder 350 decodes the denoised image features 345 to obtain an output image 355 in pixel space 310. In some cases, an output image 355 is created at each of the various noise levels. The output image 355 can be compared to the original image 305 to train the reverse diffusion process 340.

In some cases, image encoder 315 and image decoder 350 are pre-trained prior to training the reverse diffusion process 340. In some examples, they are trained jointly, or the image encoder 315 and image decoder 350 and finetuned jointly with the reverse diffusion process 340.

The reverse diffusion process 340 can also be guided based on a text prompt 360, or another guidance prompt, such as an image, a layout, a segmentation map, etc. The text prompt 360 can be encoded using a text encoder 365 (e.g., a multimodal encoder) to obtain guidance features 370 in guidance space 375. The guidance features 370 can be combined with the noisy features 335 at one or more layers of the reverse diffusion process 340 to ensure that the output image 355 includes content described by the text prompt 360. For example, guidance features 370 can be combined with the noisy features 335 using a cross-attention block within the reverse diffusion process 340. The process may be repeated to generate frames of a video or may be carried out on a spectrogram data and passed through a vocoder to generate sound. According to some aspects, diffusion models that are used to generate videos and/or sound may include additional architectural adaptations, such as temporal layers that ensure coherency between frames or waveforms.

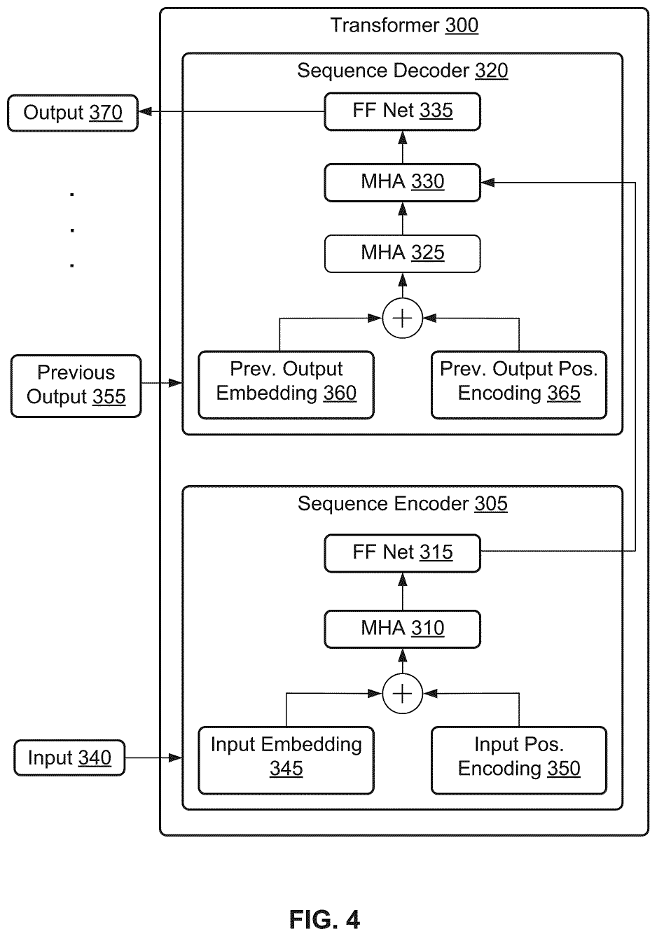

FIG. 4 shows an example of a Transformer architecture according to aspects of the present disclosure. Transformer architectures may be used in components of the image processing system such as in condition encoders, text encoders, and image generation models. Transformers perform what are referred to as “attention operations” to refine embedding representations of data.

A transformer or transformer network is a type of neural network model used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a. This technology may be used to process text as well as other modalities, such as image features. For example, a diffusion transformer (DiT) uses a transformer backbone to perform a generative denoising task.

FIG. 4 shows an example of a transformer network according to aspects of the present disclosure. The example shown includes transformer 400, sequence encoder 405, sequence decoder 420, input 440, input embedding 445, input positional encoding 450, previous output 455, previous output embedding 460, previous output positional encoding 465, and output 470.

In some cases, sequence encoder 405 includes multi-head self-attention sublayer 410 and feed-forward network sublayer 415. In some cases, sequence decoder 420 includes first multi-head self-attention sublayer 425, second multi-head self-attention sublayer 430, and feed-forward network sublayer 435.

According to some aspects, a machine learning model (such as the image generation model described with reference to FIG. 2) comprises transformer 400. In some cases, sequence encoder 405 is configured to map input 440 (for example, a query or a prompt comprising a sequence of words or tokens) to a sequence of continuous representations that are fed into sequence decoder 420. In some cases, sequence decoder 420 generates output 470 (e.g., a prediction of an output sequence of words or tokens) based on the output of sequence encoder 405 and previous output 455 (e.g., a previously predicted output sequence), which allows for the use of autoregression.

For example, in some cases, sequence encoder 405 parses input 440 into tokens and vectorizes the parsed tokens to obtain input embedding 445, and adds input positional encoding 450 (e.g., positional encoding vectors for input 440 of a same dimension as input embedding 445) to input embedding 445. In some cases, input positional encoding 450 includes information about relative positions of words or tokens in input 440.

In some cases, sequence encoder 405 comprises one or more encoding layers (e.g., six encoding layers) that generate contextualized token representations, where each representation corresponds to a token that combines information from other input tokens via self-attention mechanism. In some cases, each encoding layer of sequence encoder 405 comprises a multi-head self-attention sublayer (e.g., multi-head self-attention sublayer 410). In some cases, the multi-head self-attention sublayer implements a multi-head self-attention mechanism that receives different linearly projected versions of queries, keys, and values to produce outputs in parallel. In some cases, each encoding layer of sequence encoder 405 also includes a fully connected feed-forward network sublayer (e.g., feed-forward network sublayer 415) comprising two linear transformations surrounding a Rectified Linear Unit (ReLU) activation:

FFN(x)=ReLU(W₁x+b₁)W₂+b₂ (1)

In some cases, each layer employs different weight parameters (W₁, W₂) and different bias parameters (b₁, b₂) to apply a same linear transformation to each word or token in input 440. In some cases, a multimodal encoder may generate tokens interpretable by the transformer from data of different modalities, such as image data, sound data, and video data. A connector network may project these tokens into the same embedding space as other modalities, e.g., the tokens representing text.

In some cases, each sublayer of sequence encoder 405 is followed by a normalization layer that normalizes a sum computed between a sublayer input x and an output sublayer(x) generated by the sublayer:

layernorm(x+sublayer(x)) (2)

In some cases, sequence encoder 405 is bidirectional because sequence encoder 405 attends to each word or token in input 440 regardless of a position of the word or token in input 440.

In some cases, sequence decoder 420 comprises one or more decoding layers (e.g., six decoding layers). In some cases, each decoding layer comprises three sublayers including a first multi-head self-attention sublayer (e.g., first multi-head self-attention sublayer 425), a second multi-head self-attention sublayer (e.g., second multi-head self-attention sublayer 430), and a feed-forward network sublayer (e.g., feed-forward network sublayer 435). In some cases, each sublayer of sequence decoder 420 is followed by a normalization layer that normalizes a sum computed between a sublayer input x and an output sublayer(x) generated by the sublayer.

In some cases, sequence decoder 420 generates previous output embedding 460 of previous output 455 and adds previous output positional encoding 465 (e.g., position information for words or tokens in previous output 455) to previous output embedding 460. In some cases, each first multi-head self-attention sublayer receives the combination of previous output embedding 460 and previous output positional encoding 465 and applies a multi-head self-attention mechanism to the combination. In some cases, for each word in an input sequence, each first multi-head self-attention sublayer of sequence decoder 420 attends only to words preceding the word in the sequence, and so transformer 400's prediction for a word at a particular position only depends on known outputs for a word that came before the word in the sequence. For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections.

In some cases, each second multi-head self-attention sublayer implements a multi-head self-attention mechanism similar to the multi-head self-attention mechanism implemented in each multi-head self-attention sublayer of sequence encoder 405 by receiving a query Q from a previous sublayer of sequence decoder 420 and a key K and a value V from the output of sequence encoder 405, allowing sequence decoder 420 to attend to each word in the input 440.

In some cases, each feed-forward network sublayer implements a fully connected feed-forward network similar to feed-forward network sublayer 415. In some cases, the feed-forward network sublayers are followed by a linear transformation and a softmax function to generate a prediction of output 470 (e.g., a prediction of a next word or token in a sequence of words or tokens).

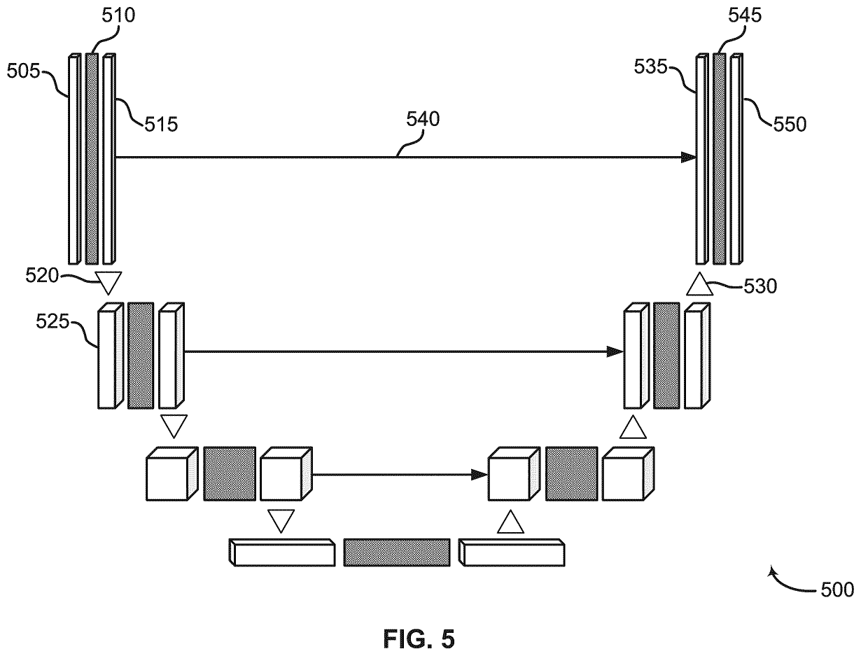

FIG. 5 shows an example of a U-Net architecture according to aspects of the present disclosure. In some examples, U-Net 500 is an example of the component that performs the reverse diffusion process 340 of guided diffusion model 300 described with reference to FIG. 3 and includes architectural elements of the image generation model 225 described with reference to FIG. 2. The U-Net 500 depicted in FIG. 5 is an example of, or includes aspects of, the architecture used within the reverse diffusion process described with reference to FIG. 3.

In some examples, diffusion models are based on a neural network architecture known as a U-Net. The U-Net 500 takes input features 505 having an initial resolution and an initial number of channels and processes the input features 505 using an initial neural network layer 510 (e.g., a convolutional network layer) to produce intermediate features 515. The intermediate features 515 are then down-sampled using a down-sampling layer 520 such that down-sampled features 525 have a resolution less than the initial resolution and a number of channels greater than the initial number of channels.

This process is repeated multiple times, and then the process is reversed. That is, the down-sampled features 525 are up-sampled using up-sampling process 530 to obtain up-sampled features 535. The up-sampled features 535 can be combined with intermediate features 515 having a same resolution and number of channels via a skip connection 540. These inputs are processed using a final neural network layer 545 to produce output features 550. In some cases, the output features 550 have the same resolution as the initial resolution and the same number of channels as the initial number of channels.

In some cases, U-Net 500 takes additional input features to produce conditionally generated output. For example, the additional input features could include a vector representation of an input prompt. The additional input features can be combined with the intermediate features 515 within the neural network at one or more layers. For example, a cross-attention module can be used to combine the additional input features and the intermediate features 515.

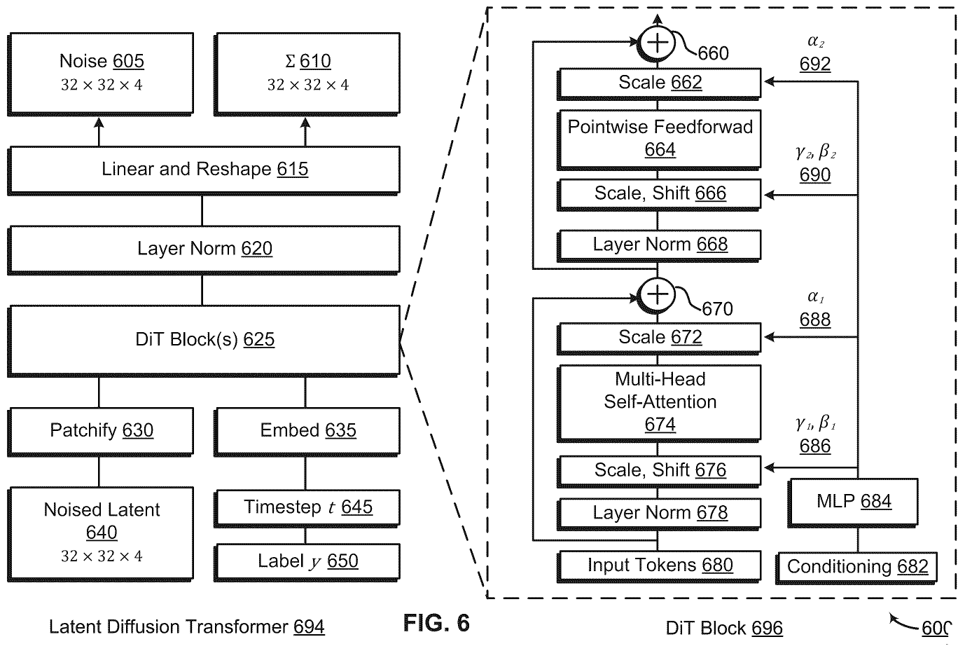

FIG. 6 shows an example of a diffusion transformer (DiT) architecture according to aspects of the present disclosure. While some generative diffusion models are based on a convolutional layer backbone (e.g., the U-Net), others may be based on a transformer network backbone. The DiT illustrated in FIG. 6 includes aspects of the image generation model 225 described with reference to FIG. 2.

The example shown includes predicted noise 605, predicted covariance 610, linear and reshape layers 615, normalization layer 620, DiT block(s) 625, patchify operation 630, embedding 635, noised latent 640, timestep information 645, label information 650, and an implementation of one block in the DiT block(s) 625 by a DiT Block 696. The DiT Block 696 includes: second residual connection 660, second scaling operations 662, feed-forward network 664, post-normalization second scaling and shifting 666, second normalization 668, first residual connection 670, first scaling operations 672, self-attention 674, post-normalization first scaling and shifting 676, first normalization 678, input tokens 680, conditioning tokens 682, multi-layer perceptron (MLP) 684, post-normalization first scaling and shifting parameters 686, first scaling parameter 688, post-normalization second scaling and shifting parameters 690, and second scaling parameter 692. In some embodiments, the architecture uses a Latent Diffusion Transformer 694. In some embodiments, DiT Block 696 uses an “adaLN-Zero” technique.

Diffusion Transformers (DiTs) is a popular architecture for diffusion models and is designed to be structurally faithful to standard transformer architecture. DiT incorporates transformer structures' scaling properties. For training denoising diffusion probabilistic models (DDPMs) of images (e.g., spatial representations of images), DiT is based on a Vision Transformer (ViT) architecture which operates on sequences of patches. DiT processes images by dividing them into patches, converting these patches into tokens, and applying attention mechanisms to model relationships between different regions of the image. This approach allows the model to capture both local and long-range dependencies in the image generation process.

In some cases, input to DiT is a spatial representation z. For 256×256×3 images, z has shape 32×32×4. A first layer of a DiT is to carry out patchify operation, where the DiT divides an input image into patches and converts the patches (a form of spatial input) into a sequence of T tokens, each of dimension d, by linearly embedding each patch in the input. Following the patchify process, ViT frequency-based positional embeddings are applied to all input tokens. In some cases, the number of tokens T created by patchify is determined by a patch size hyperparameter p. In some cases, T=(I/p)², where I is another shape parameter, thus halving p will quadruple T, which in some cases at least quadruples total of transformer Giga Floating Point Operations (Gflops). Accordingly, embodiments herein can increase inference speed by configuring and operating within a highly compressed latent space, resulting in fewer processed tokens relative to higher spatial dimension (e.g., H×W) spaces. In some examples, changing p has no impact on downstream parameter counts, i.e., parameter counts in downstream layers of DiT is independent from p. In some examples, p=2, 4 or 8. Various patch sizes, transformer block architectures and model sizes are implemented.

Following Patchify operation, attention mechanisms are applied to model relationships between different regions of the image in one or more DiT blocks. In addition to noised image inputs, diffusion models sometimes process additional conditional information such as noise timesteps t, class labels c, natural language information, etc. Four variants of transformer blocks for processing conditional inputs including both input information and conditional information are described below.

In some cases, DiT blocks in the DiT network are implemented using adaptive layer norm (adaLN) blocks. Following adaptive normalization layers in generative adversarial networks (GANs) and conventional diffusion models with U-Net backbones, in some examples, standard normalization layers in transformer blocks are replaced with adaptive layer norm (adaLN). Rather than directly learning dimension-wise scale γ and shift parameters β, in adaLN the system regresses γ and β from a sum of the embedding vectors of the noise timesteps t and the class labels c. An adaLN adds relatively small numbers of Gflops and is more efficient. Additionally, adaLN is a conditioning mechanism that applies a same function to all tokens.

In some cases, DiT blocks in the DiT network are implemented using adaLN-Zero blocks, which leverages zero-initialization techniques. In Residual Networks (ResNets), initializing each residual block as the identity function x→x is beneficial. In some examples, zero-initializing a final batch norm scale factor γ in each block accelerates large-scale training in supervised learning settings. Diffusion models based on U-Nets use a similar initialization strategy, zero-initializing final convolutional layer in each block prior to residual connections. An adaLN-Zero block is modified from an adaLN block using similar zero-initialization techniques. In addition to regressing the dimension-wise scale γ and the shifting parameters β, the system also regresses dimension-wise scaling parameters as that are applied immediately prior to residual connections within the DiT block. The network initializes a multi-layer perceptron (ILP) to output a zero-vector for all αs; this initializes an entire DiT block as the identity function. As with the adaLN block, adaLNZero adds negligible Gflops to the model.

In some cases, DiT blocks in the DiT network are implemented using in-context conditioning, where vector embeddings of t and c are appended as two additional tokens in the input sequence, and after a final block, the network removes the two conditioning tokens from the sequence.

In some cases, DiT blocks in the DiT network include cross-attention blocks. The DiT network concatenates the embeddings of t and c into a length-two sequence, separate from the image token sequence. The transformer block is modified to include an additional multi-head cross-attention layer following the multi-head self-attention block.

In some cases, the DiT network includes a sequence of N DiT blocks, each operating at a hidden dimension size d. Following ViT, the DiT network uses standard transformer configs that jointly scale N, d and attention heads. In some examples, Small (S), Base (B), Large (L) variants, XLarge (XL) variants of model sizes are implemented. Small or Base model sizes have N=12 layers of DiT blocks, Large model sizes have 24 layers of DiT blocks. XLarge model sizes have 28 layers of DiT blocks.

After a final DiT block, the DiT network decodes the sequence of image tokens into an output noise prediction and an output diagonal covariance prediction. Both outputs have shape equal to an original spatial input. Standard linear decoder is utilized to decode, wherein a final normalization layer (or adaptive normalization layer if the DiT block is an adaLN block) and linearly decode each token into a p×p×2C tensor, where C is a number of channels in the spatial input to the DiT network and p is the patch size hyperparameter. Finally, decoded tokens are rearranged into their original spatial layout to get the predicted noise and covariance.

The architecture 600, in some cases, uses a Latent Diffusion Transformer 694. The architecture 600 processes noised latent 640, which may be a noised version of an input image encoded in a latent space. Patchify operation 630 divides the noised latent into a sequence of patches that are processed as tokens. The tokens are vector representations of each patch of the image in latent space and are adjusted through attention processes. Each of the tokens also receives timestep information 645 and label information 650 and, accordingly, their embedding 635, which encodes the current denoising timestep and class labels as conditional information. In some cases, embedding 635 is referred to as conditional embedding or conditional information embedding. In some cases, a positional embedding which encodes each token's spatial position in the image is applied to the patchified input tokens at the patchify operations 630. In some examples the positional embedding is ViT frequency-based positional embedding. The input tokens 680 generated by the patchify operation 630 and the conditioning tokens 682 generated by the embedding 635 are processed through N DiT block(s) 625, where N may be 62, 24 or 28. Other values of N may be used. In some cases, conditional tokens refer to tokens generated based on embedding 635 encoding timestep information 645 and label information 650.

Each of the DiT block(s) 625 includes multiple processing stages. DiT Block 696 illustrates an embodiment of one block in the DiT block(s) 625. In some embodiments, the DiT Block 696 is an example of, or includes aspects of, the adaLN-Zero block. In some cases, input tokens 680 interact with the conditioning tokens 682 through multiple attention mechanisms. Particularly, after first normalization 678 applied to the input tokens and MLP 684 to the conditional tokens, MLP 684 generates or updates post-normalization first scaling and shifting parameters 686, denoted as γ₁, β₁, for post-normalization first scaling and shifting 676 to scale and shift the output of first normalization 678 accordingly. As the normalized input tokens obtained from first normalization 678 are scaled and shifted at post-normalization first scaling and shifting 676 using the conditional information carried as least in γ₁, β₁, this allows the input information and conditional information to interact. Self-attention 674 allows the scaled and shifted normalized input tokens, namely the output from post-normalization first scaling and shifting 676, to attend to each other. MLP 684 also generates or updates first scaling parameter 688 denoted as α₁ for first scaling operations 672 to scale the output of self-attention 674 (e.g., multi-head self-attention), further interacting the input information and conditional information. The input tokens 680 is then summed with the output of first scaling operations 672 at first residual connection 670. In some examples, α₁ has initial values 0, and the DiT Block 696 is initialized as the identity function.

A similar process is performed in a second half of the DiT Block 696. MLP 684 generates or updates post-normalization second scaling and shifting parameters 690, denoted as γ₂, β₂, for post-normalization second scaling and shifting 666 to scale and shift the output of second normalization 668 accordingly. As the output from second normalization 668 is scaled and shifted using the conditional information carried at least in γ₂, β₂, this allows the input information and conditional information to further interact. Feed-forward network 664 then processes the scaled and shifted output from post-normalization second scaling and shifting 666. MLP 684 also generates or updates second scaling parameter 692 denoted as α₂ for second scaling operations 662 to scale the output of feed-forward network 664, further interacting the input information and conditional information. In some cases, the feed-forward network 664 is a pointwise feed-forward network. The output from first residual connection 670 is then summed with the output of second scaling operations 662 at second residual connection 660, and the result is the final output of DiT Block 696. In some examples, α₂ has initial values 0, and the DiT Block 696 is initialized as the identity function. This process repeats for each DiT block in the sequence.

After processing through all DiT block(s) 625, the outputs undergo normalization layer 620 followed by linear and reshape layers 615. The final output is the predicted noise 605, which represents the model's prediction of the noise that was added to initially create the noised latent 640, and the predicted covariance 610, which represents the model's prediction of the covariance. The predicted noise 605 is removed from noised latent 640 at each diffusion timestep, and the predicted covariance may affect how noise is removed or resampled in the reverse or denoising process. At the end of the denoising schedule, the latent sample is decoded to generate the synthetic image in pixel space.

FIG. 7 shows an example of a U-Net diffusion transformer (UDiT) architecture according to aspects of the present disclosure. The example shown includes condition encoders 700, conditioning tokens 705, visual tokens 710, initial DiT blocks 715, downsampling linear layer 720, compressed conditioning tokens 725, compressed visual tokens 730, intermediate DiT blocks 735, upsampling linear layer 740, terminal DiT blocks 745, skip connection 750, and synthetic image 755. The UDiT illustrated in FIG. 7 includes aspects of the image generation model 225 described with reference to FIG. 2. Embodiments of the image generation model described herein may be based on a U-Net, a DiT, or a UDiT.

In this example UDiT architecture, the model processes both conditioning information and visual information through a series of transformer blocks arranged in a U-shaped structure. The UDiT begins with condition encoders 700 that process input prompts to generate conditioning tokens 705. Input prompts may include, for example, text descriptions, reference image(s), or aesthetic/style/other-guidance directives. In some embodiments, visual tokens 710 may be initialized from random noise or partially denoised tokens, depending on the current denoising timestep in the diffusion process.

The initial DiT blocks 715 process the visual tokens 710 along with the conditioning tokens 705 through transformer operations including self-attention and feed-forward networks. These initial blocks operate on tokens with a first patch size (e.g., 1×1 pixel patches). The first patch size may be an uncompressed patch size which allows the model to capture fine-grained details in the visual representation.

Following the initial DiT blocks 715, a downsampling linear layer 720 compresses the spatial dimensions of both the visual and conditioning information. The downsampling linear layer 720 may be a learned linear layer. This compression produces compressed conditioning tokens 725 and compressed visual tokens 730, which have a second patch size (e.g., 2×2 pixel patches) that is larger than the first patch size. In some embodiments, the compressed tokens contain fewer tokens overall but utilize a higher embedding dimension than the uncompressed tokens, which preserves information while reducing the total number of tokens that must be processed by subsequent attention operations.

The intermediate DiT blocks 735 then process these compressed tokens. Due to the reduced token count, these operations are computationally more efficient than if performed on the uncompressed tokens, as the computational complexity of attention operations scales quadratically with the number of tokens. Despite this compression, the model maintains high-quality generation capabilities as the embedding dimension is increased to preserve information capacity.

After processing through the intermediate DiT blocks 735, the upsampling linear layer 740 decompresses the tokens back to the original patch size and spatial dimensions, while reducing the embedding dimension. The terminal DiT blocks 745 then process these uncompressed tokens to produce the final output.

In some embodiments, some embodiments, a skip connection 750 connects the output of one or more initial DiT blocks 715 directly to the input of one or more terminal DiT blocks 745. This skip connection may assist in preserving fine-grained spatial information that might otherwise be lost during the compression and decompression process and improve the model's ability to generate detailed features in the synthetic image 755.

The UDiT architecture combines advantages of both U-Net structures (downsampling, upsampling, and skip connections) and transformer-based DiT models (self-attention for global context). This approach enables efficient processing of visual information while maintaining generation quality, particularly for fine details in the synthetic image 755. In some embodiments, the architecture achieves comparable or superior quality to standard DiT models while significantly reducing computational requirements during inference.

FIG. 8 shows an example of a training pipeline according to aspects of the present disclosure. The example shown includes noisy input 800, image generation model 805, predicted denoised image 810, forward diffusion 815, teacher model 820, real score 825, auxiliary model 830, fake score 835, denoising loss 840, gradient term 845, real image 850, discriminator model 855, GAN loss 860, paired data 865, and ODE matching loss 880.

Image generation model 805 is an example of, or includes aspects of, the corresponding element described with reference to FIG. 2. Teacher model 820 is an example of, or includes aspects of, the corresponding element described with reference to FIG. 2.

In this example pipeline, the training of image generation model 805 incorporates multiple complementary loss functions to ensure high-quality generation results. The primary training signal includes distribution matching distillation (DMD), which minimizes the Kullback-Leibler divergence between distributions produced by the teacher model 820 and an auxiliary model 830. During training, the image generation model 805 receives noisy input 800 and produces a predicted denoised image 810, which undergoes forward diffusion 815 to various noise levels for score computation. The teacher model 820 and auxiliary model 830 then evaluate these noise-corrupted outputs to produce real score 825 and fake score 835, respectively, which are combined to compute the gradient term 845 used to update the parameters of the image generation model 805. Concurrently, the auxiliary model 830 is updated using denoising loss 840 to accurately track the evolving distribution of the image generation model's outputs.

In some embodiments, the training pipeline incorporates an ODE matching loss 880 that ensures the image generation model 805 accurately reproduces the continuous denoising trajectory of the teacher model 820. This approach utilizes paired data 865 comprising random noise inputs and corresponding high-quality reference outputs obtained by sampling the teacher model with a deterministic ODE solver. The ODE matching loss 880 serves as a regularizer that helps prevent mode collapse and preserves fine details in generated outputs, particularly at low noise levels where distribution matching alone may become unreliable.

Additionally, some embodiments implement adversarial training using a discriminator model 855 that distinguishes between real image 850 and outputs from image generation model 805. The discriminator model 855 provides a GAN loss 860 that enables the image generation model to potentially surpass the teacher model in sample quality by addressing approximation errors in the score functions. This multi-faceted training approach combining distribution matching, ODE matching, and adversarial learning provides complementary signals that guide the image generation model 805 toward producing high-quality, realistic outputs while maintaining computational efficiency during inference.

In some embodiments, the training process alternates between updating different components of the pipeline to ensure stable convergence. For example, training may alternate between 1) training the image generation model 805 using the gradient term 845 and GAN loss 860 for N iterations, and 2) training the auxiliary model 830 using denoising loss 840 and the discriminator model 855 using the GAN loss 860 for M iterations. This alternating schedule helps maintain consistency between the evolving distribution of the image generation model's outputs and the auxiliary model's approximation of that distribution, while also ensuring the discriminator provides a meaningful adversarial signal throughout training.

### Distribution Matching Distillation

Embodiments of the present disclosure incorporate distribution matching distillation (DMD) in the training of a student media generation model. There are various approaches to implementing a DMD matching loss. One approach is described in the following.

The system may compute a distribution-matching loss that combines an output from a teacher model (“first term”) and an output from an unlocked and jointly-trained auxiliary model (“second term”). This multi-term loss guides the few-step image generation model towards the distribution of the pre-trained model by minimizing the divergence between their respective output distributions. The use of the multi-term loss provides an information-rich learning vector for training the few-step generation model. The media generation model retains its high-quality, realistic generation ability even when used for text-to-image generation.

In some embodiments, the student model, a few-step generator G_{θ}, includes the same architecture as the teacher model, e.g., a diffusion transformer (DiT). In at least one embodiment, the parameters of the few-step generator G_{θ} are initialized to the parameters of μ_{base}. During training, embodiments minimize the Kullback-Leibler (KL) divergence between the “real” distribution produced by the pre-trained model, the score of which is μ_{base}, and the “fake” distribution, whose score is provided by the jointly-trained auxiliary model, calculated for outputs from the untrained few-step generator G_{θ}. This objective is given by Equation X:

$$\begin{matrix}{D}_{KL} ( {p}_{fake} ‖ {p}_{real} ) = {𝔼}_{x \sim {p}_{fake}} ( log \frac{{p}_{fake} ( x )}{{p}_{real} ( x )} ) \\ = {𝔼}_{\begin{matrix}z \sim 𝒩 ( 0 ; I ) \\ x = {G}_{θ}\end{matrix}} - ( log {p}_{real} ( x ) - log {p}_{fake} ( x ) )\end{matrix} \qquad ( 3 )$$

Where pᵣₑₐₗ and p_{fake} are the real and fake distributions, respectively. In some cases, computing the probability densities to estimate this loss is intractable; however, embodiments do not compute the probability densities directly. Instead, embodiments compute a gradient term with respect to the parameters θ to train G_{θ} by gradient descent.

According to some aspects, the gradient term is computed as a combination of scores output from the teacher model and the student model. The score is defined as the gradient of the log probability at each step of noise addition. The score guides the model in reversing the noise addition to regenerate the data. Multi-step diffusion models such as the teacher model μ_{base} and jointly-trained auxiliary model μ_{fake} can be thought of as “score functions” that are configured to produce scores of the real and fake distributions for the denoising process using the output of few-step generator G_{θ} (e.g., the “student” model). Taking the gradient of Eq. (4) with respect to the parameters θ of G_{θ} yields the following:

$${∇}_{θ} {D}_{KL} = {𝔼}_{\begin{matrix}z \sim 𝒩 ( 0 ; I ) \\ x = {G}_{θ} ( z )\end{matrix}} [ - ( {s}_{real} ( x ) - {s}_{fake} ( x ) ) {∇}_{θ} {G}_{θ} ( z ) ] \qquad ( 4 )$$

where sᵣₑₐₗ(x)=∇ₓ log pᵣₑₐₗ(x) and s_{fake}(x)=∇ₓ log p_{fake}(x) are the scores of the respective distributions.

The score function is a way to formulate the denoising problem that leverages gradients of probability densities rather than the densities themselves. Specifically, the score represents the gradient of the log probability density with respect to the data ∇ₓ log p(x)), pointing in the direction of increasing probability. This formulation is useful in diffusion models because it allows the model to learn the direction to move noisy samples toward higher probability regions of the data distribution without having to explicitly calculate the intractable probability densities. By training models to estimate these scores at different noise levels, the models guide the generative process from random noise toward realistic data samples through a series of refinement steps. The score sᵣₑₐₗ represents a direction that moves x towards the mode(s) of pᵣₑₐₗ, and −s_{fake} meanwhile is a direction that diverges x from the mode(s) of p_{fake}.

In some cases, embodiments perturb the output of few-step generator GO with noise using a forward diffusion process so as to create a family of “blurred” distributions that are fully supported over the ambient space, and therefore overlap, so that the gradient of Eq. (4) is well-defined. The addition of noise to output x produces diffused sample xₜ~q(xₜ|x) at diffusion time step t:

$${q}_{t} ( {x}_{t} \vert x ) \sim 𝒩 ( {α}_{t} x ; {σ}_{t}^{2} I ) \qquad ( 5 )$$

where αₜ and σₜ are from the diffusion noise schedule.

To compute the “real” score (e.g., the first term), embodiments use the pre-trained diffusion denoiser μ_{base}, also referred to as the “teacher” or “teacher” model. The score as produced from a diffusion model is given by the following:

$${s}_{real} ( {x}_{t} , t ) = - \frac{{x}_{t} - {α}_{t} {μ}_{base} ( {x}_{t} , t )}{{σ}_{t}^{2}} \qquad ( 6 )$$

and similarly so for the “fake” score:

$${s}_{fake} ( {x}_{t} , t ) = - \frac{{x}_{t} - {α}_{t} {μ}_{fake}^{ϕ} ( {x}_{t} , t )}{{σ}_{t}^{2}} \qquad ( 7 )$$

Since the few-step generator G_{θ} is actively updated through the backpropagation of the gradient term, its output distribution is constantly changing. Accordingly, the second diffusion model μ_{fake}^{φ} e.g., the jointly-trained auxiliary model, is dynamically adjusted to track these changes. In at least one embodiment, μ_{fake}^{φ} is initialized from the pre-trained diffusion model μ_{base}, and parameters Of μ_{fake}^{φ} are updated during training by minimizing a standard denoising objective:

$${ℒ}_{denoise}^{ϕ} = {‖ {μ}_{fake}^{ϕ} ( {x}_{t} , t ) - {x}_{0} ‖}_{2}^{2} \qquad ( 8 )$$

where

$${ℒ}_{denoise}^{ϕ}$$

is weighted according to the diffusion timestep t. According to some aspects, the loss is weighted according to the same weighting strategy employed during the pre-training Of μ_{base}.

Accordingly, embodiments approximate the gradient term by combining the scores s_{fake} and sᵣₑₐₗ on the noise-added outputs from Go and take the expectation over the diffusion time steps:

$${∇}_{θ} {D}_{KL} ≃ {𝔼}_{z , t , x , {x}_{t}} [ {w}_{t} {α}_{t} ( {s}_{fake} ( {x}_{t} , t ) - {s}_{real} ( {x}_{t} , t ) ) {∇}_{θ} {G}_{θ} ( z ) ] \qquad ( 9 )$$

where z~ [symbol] (0, I), x=G_{θ}(z), t~ [symbol] (Tₘᵢₙ, Tₘₐₓ), xₜ~q(xₜ|x), and wₜ is a time-dependent scalar weight included to improve training stability. In some embodiments, wₜ is computed to normalize the gradient term's magnitude across different noise levels. For example, in one embodiment, wₜ is computed as the mean absolute error across spatial and channel dimensions between the denoised image and the input, like so:

$${w}_{t} = \frac{{α}_{t}^{2}}{{α}_{t}} \frac{CS}{{‖ {μ}_{base} ( {x}_{t} , t ) - x ‖}_{1}} \qquad ( 10 )$$

where S is the number of spatial locations and C is the number of channels.

### ODE Matching

In some embodiments, the training process incorporates ODE Matching to ensure the few-step generator G_{θ} accurately reproduces the continuous denoising trajectory of the teacher model. This approach helps address potential limitations of distribution matching when noise levels are low and helps prevent mode collapse by ensuring all modes of the distribution are preserved. There are various approaches to implementing an ODE matching loss. One approach is described in the following.

According to some aspects, embodiments build a paired dataset D={z, y} comprising random Gaussian noise images z and corresponding outputs y obtained by sampling the pre-trained diffusion model μ_{base} using a deterministic ODE solver. In at least one embodiment, the ODE solver employs a fixed number of sampling steps to generate high-quality reference outputs from the teacher model.

During training, embodiments minimize a regression loss between the outputs of the few-step generator and the reference outputs from the teacher model. This objective is given by Equation 11:

$${ℒ}_{reg} = {𝔼}_{( z , y ) \sim 𝒟} ℓ ( {G}_{θ} ( z ) , y ) \qquad ( 11 )$$

where [symbol] represents a distance function measuring perceptual similarity between the generated output G_{θ}(z) and the reference output y. In some embodiments, the distance function comprises a Learned Perceptual Image Patch Similarity (LPIPS) metric that better captures visual fidelity compared to pixel-wise losses.

According to some aspects, this regression loss is used as an effective regularizer even with a relatively small number of noise-image pairs. In at least one embodiment, generating the paired dataset requires less than 1% of the training compute used for the original model pre-training.

The ODE Matching objective ensures that the few-step generator's outputs align with the integral trajectory of the teacher's denoising diffusion process, as characterized by the solution to the corresponding ordinary differential equation. This alignment is useful at low noise levels where distribution matching alone may become unreliable due to the real distribution approaching zero probability density. In at least one embodiment, the ODE matching objective is not included to increase the training speed.

In some embodiments, the final training objective for Go combines the distribution matching loss and the regression loss:

D_{KL}+γ_{reg} [symbol] _{reg} (12)

where λ_{reg} is a weighting parameter that balances the two loss terms. The jointly-trained

$${μ}_{fake}^{ϕ}$$

continues to be updated using the denoising loss

$${ℒ}_{denoise}^{ϕ}$$

as described in the previous section.

### GAN Training

In some embodiments, the training process incorporates an adversarial learning objective to further improve the quality of outputs from the few-step generator GO. This approach may enable the student model to potentially surpass the parent model in sample quality by addressing approximation errors in the score functions, and/or by introducing guidance that helps the image generation model generate more realistic outputs.

According to some aspects, embodiments implement a discriminator network . . .

During training, embodiments minimize a GAN objective between outputs of the few-step generator and real data samples. This objective may be represented as:

$${ℒ}_{GAN} = {𝔼}_{x \sim {p}_{real} , t \sim [ 0 , T ]} [ log {D}_{ψ} ( F ( x , t ) ) ] + {𝔼}_{z \sim {p}_{noise} , t \sim [ 0 , T ]} [ - log {D}_{ψ} ( F ( {G}_{θ} ( z ) , t ) ) ] \qquad ( 13 )$$

where D_{ψ} is the discriminator network, and F is the forward diffusion process that injects noise corresponding to time step t. According to some aspects, the noise level t is sampled from a range [0, T] during training, enabling the discriminator to evaluate the quality of generated images at various noise levels.

In some embodiments, the discriminator network D_{ψ} is implemented as a separate set of parameters from the jointly-trained model μ_{fake}. Unlike approaches that share parameters between these models, embodiments maintain a clear separation between the scoring function and the discriminatory function. In at least one embodiment, the discriminator D_{ψ} is configured to process complete outputs from the few-step generator G_{θ} after forward diffusion, as well as similarly noise-corrupted real images, rather than operating on intermediate feature representations.

According to some aspects, the GAN objective is consistent with the distribution matching philosophy as it operates directly on the output distributions without requiring paired data or explicit knowledge of the parent model's sampling trajectories. In at least one embodiment, the GAN objective provides a complementary learning signal that encourages the few-step generator G_{θ} to produce high-quality, realistic outputs that can be indistinguishable from real data even at noise levels where the parent model's score approximation may be suboptimal.

In some embodiments, the discriminator network D_{ψ} is initialized with parameters from the parent model μ_{base} and then fine-tuned for the classification task. This initialization leverages the rich feature representations already learned by the parent model while adapting them to the specific requirements of adversarial training. According to some aspects, this approach accelerates training convergence and improves overall performance compared to training the discriminator from randomly initialized parameters.

### Inference Hybrid Sampling

In some embodiments, the image generation process employs a hybrid sampling scheme that combines the strengths of both the teacher model and the trained student model. According to some aspects, this approach balances the high quality and accuracy of the teacher model with the inference efficiency of the student model.

During inference, embodiments may receive a text prompt P, an initial noise sample x_{T}, and a parameter indicating the total sampling steps N. For each time step t in the denoising process, the system passes the current noisy sample xₜ and prompt P to both the teacher model and the student model to obtain predicted noise terms ϵ_{teacher}(xₜ, P) and ϵ_{student}(xₜ, P), respectively.

According to some aspects, a controller determines a mixing weight αₜ∈{0, 1} for each timestep. In some embodiments, the mixing weight may be determined according to a fixed schedule, an adaptive policy based on current generation quality, or a learned function that optimizes the quality-efficiency tradeoff. The system then computes a hybrid prediction by combining the teacher and student predictions according to Equation 14:

ϵ_{Hybrid}(xₜ,P)=αₜ·ϵ_{teacher}(xₜ,P)+(1−αₜ)·ϵ_{student}(xₜ,P) (14)

In at least one embodiment, the system updates the sample for the next timestep xₜ₋₁ using the hybrid noise term ϵ_{Hybrid} via the standard reverse diffusion formula. This process continues iteratively until reaching x₀, which represents the final generated image.

According to some aspects, the mixing weights αₜ may follow various schedules. In one embodiment, the weights may be set to 1 (full teacher model) for the first k steps and 0 (full student model) for the remaining N−k steps, which uses the teacher model during a first inference phase, and then the trained student model in a second inference phase. In another embodiment, the weights may be set to 1 only for specific timesteps where the teacher model's expertise significantly impacts output quality.

In some embodiments, the hybrid sampling approach improves generation robustness, particularly for rare or ambiguous text prompts where the distilled student model may otherwise produce lower quality results. According to some aspects, this hybrid architecture can be integrated with any diffusion-based text-to-image framework and reused across different training checkpoints without requiring modification to the underlying models.

According to some aspects, auxiliary model 830 computes a second score function for the image generation model 805 using an auxiliary model 830, where the distribution matching loss is based on a difference between the first score function and the second score function.

According to some aspects, discriminator model 855 computes a GAN loss 860 for the image generation model 805 using a discriminator model 855, where the discriminator model 855 classifies an output of the image generation model 805.

According to some aspects, discriminator model 855 computes a GAN loss 860 for the image generation model 805 using a discriminator model 855, where the image generation model 805 is trained using the GAN loss 860. In one aspect, paired data 865 includes pure noise sample 870 and teacher model output 875.

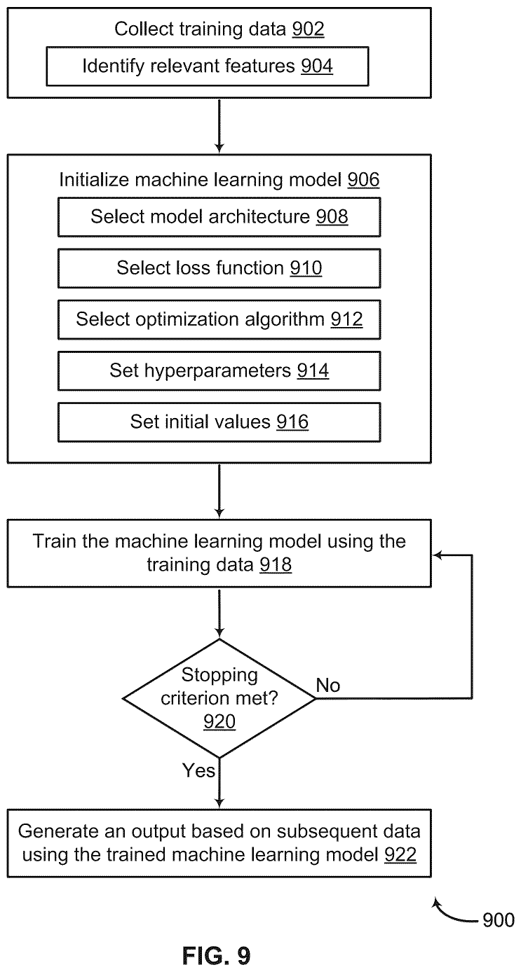

FIG. 9 is a flow diagram depicting an algorithm as a step-by-step procedure 900 in an example implementation of operations performable for training a machine-learning model. The procedure 900 provides one or more examples of generating training data, use of the training data to train a machine-learning model, and use of the trained machine-learning model to perform a task.

To begin in this example, a machine-learning system collects training data (block 902) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 904) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 906). Initialization of the machine-learning model includes selecting a model architecture (block 908) to be trained. Examples of model architectures include neural networks, convolutional neural networks (CNNs), long short-term memory (LSTM) neural networks, transformer networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 910). The loss function is utilized to measure a difference between an output of the machine-learning model (i.e., predictions) and target values (e.g., as expressed by the training data) to be used to train the machine-learning model. Additionally, an optimization algorithm is selected (912) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 914) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 918) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 920), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 920), the procedure 900 continues training of the machine-learning model using the training data (block 918) in this example.

If the stopping criterion is met (“yes” from decision block 920), the trained machine-learning model is then utilized to generate an output based on subsequent data (block 922). The trained machine-learning model, for instance, is trained to perform a task as described above and therefore, once trained is configured to perform that task based on subsequent data received as an input and processed by the machine-learning model.

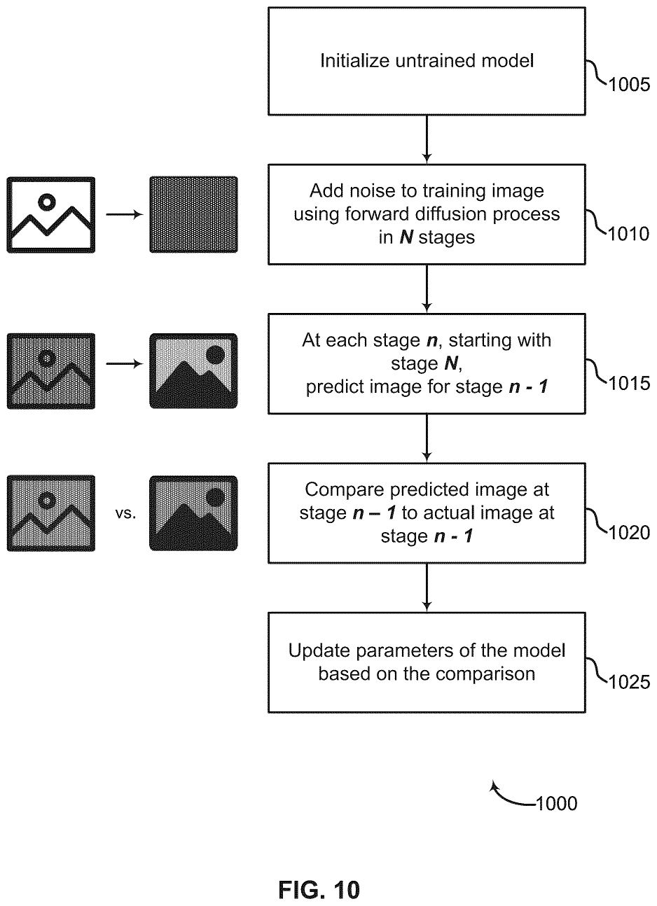

FIG. 10 shows an example of a method 1000 for training a diffusion model according to aspects of the present disclosure. In some embodiments, the method 1000 describes an operation for configuring the image generation model 225 as described with reference to FIG. 2. In some examples, these operations are performed by a system including a processor executing a set of codes to control functional elements of an apparatus, such as the guided diffusion model described in FIG. 3

Additionally or alternatively, certain processes of method 1000 may be performed using special-purpose hardware. Generally, these operations are performed according to the methods and processes described in accordance with aspects of the present disclosure. In some cases, the operations described herein are composed of various substeps or are performed in conjunction with other operations.

At operation 1005, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1010, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1015, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1020, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 1025, the system updates parameters of the model based on the comparison. For example, parameters of a U-Net or a DiT may be updated using gradient descent. Time-dependent parameters of the Gaussian transitions can also be learned.

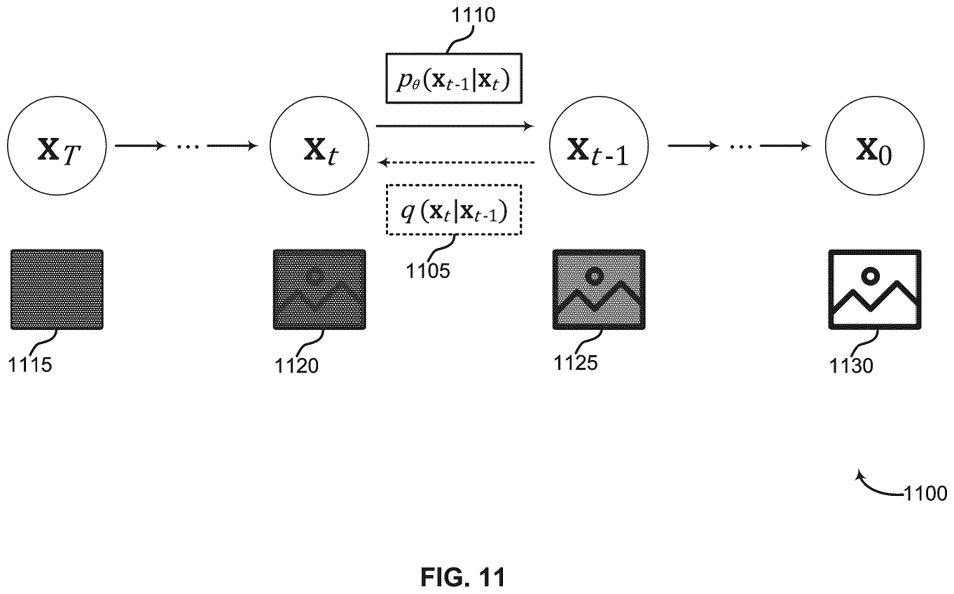

FIG. 11 shows a diffusion process 1100 according to aspects of the present disclosure. In some examples, diffusion process 1100 describes an operation of the image generation model 225 described with reference to FIG. 2, such as the reverse diffusion process 340 of guided diffusion model 300 described with reference to FIG. 3. According to some aspects, the diffusion process can also be used in the generation of sounds and videos.

As described above with reference to FIG. 3, using a diffusion model can involve both a forward diffusion process 1105 for adding noise to an image (or features in a latent space) and a reverse diffusion process 1110 for denoising the images (or features) to obtain a denoised image. The forward diffusion process 1105 can be represented as q(xₜ|xₜ₋₁), and the reverse diffusion process 1110 can be represented as p(xₜ₋₁|xₜ). In some cases, the forward diffusion process 1105 is used during training to generate images with successively greater noise, and a neural network is trained to perform the reverse diffusion process 1110 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network such as a U-Net based ANN, a DiT, or a UDiT may be trained to perform the reverse process. During the reverse diffusion process 1110, the model begins with noisy data x_{T}, such as a noisy image 1115 and denoises the data to obtain the p(xₜ₋₁|xₜ). At each step t−1, the reverse diffusion process 1110 takes xₜ, such as first intermediate image 1120, and t as input. Here, t represents a step in the sequence of transitions associated with different noise levels. The reverse diffusion process 1110 outputs xₜ₋₁, such as second intermediate image 1125 iteratively until x_{T} reverts back to x₀, the original image 1130. The reverse process can be represented as:

p_{θ}(xₜ₋₁|xₜ):=N(xₜ₋₁;μ_{θ}(xₜ,t),Σₑ(xₜ,t)) (14)

In some examples, the reverse diffusion process can alternatively be formulated in terms of a score function, defined as the gradient of the log probability density with respect to the data: ∇ₓ log p(x). This score function indicates the direction of increasing probability density and guides the denoising process at each step. The connection between the conditional mean μ_{θ} in Equation (14) and the score-based formulation can be expressed by showing that the optimal denoising direction is proportional to the score of the noisy data distribution at that noise level. The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} )$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data z is mapped back into the pixel space from the latent space as output. In some examples, x₀ represents an original input image with low image quality, latent variables x₁, . . . , x_{T} represent noisy images, and \tilde{x} represents the generated image with high image quality.

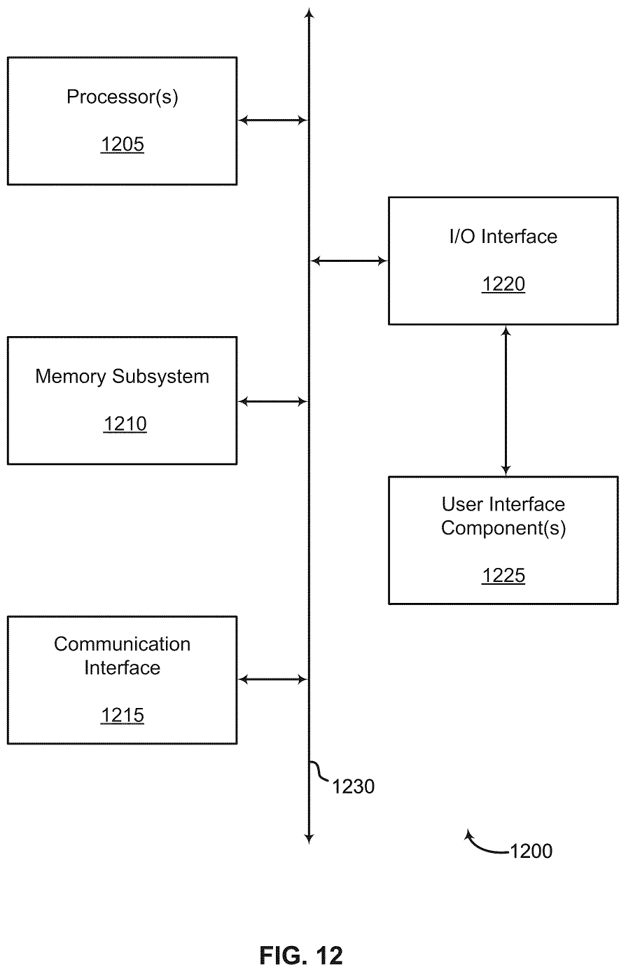

FIG. 12 shows an example of a computing device 1200 according to aspects of the present disclosure. The example shown includes computing device 1200, processor(s) 1205, memory subsystem 1210, communication interface 1215, I/O interface 1220, user interface component(s), and channel 1230.

In some embodiments, computing device 1200 is an example of, or includes aspects of, image processing apparatus 200 of FIG. 2, or the perceptual similarity apparatus of FIG. 3, or both. In some embodiments, computing device 1200 includes one or more processors 1205 are configured to execute instructions stored in memory subsystem 1210 to obtain a teacher model trained to generate synthetic images; compute a distribution matching loss for the image generation model using the teacher model; compute a GAN loss for the image generation model using a discriminator model, wherein the discriminator model classifies an output of the image generation model; and train the image generation model to generate synthetic images using the distribution matching loss and the GAN loss.

According to some aspects, computing device 1200 includes one or more processors 1205. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1215 operates at a boundary between communicating entities (such as computing device 1200, one or more user devices, a cloud, and one or more databases) and channel 1230 and can record and process communications. In some cases, communication interface 1215 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1220 is controlled by an I/O controller to manage input and output signals for computing device 1200. In some cases, I/O interface 1220 manages peripherals not integrated into computing device 1200. In some cases, I/O interface 1220 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1220 or via hardware components controlled by the I/O controller.

According to some aspects, user interface component(s) 1225 enable a user to interact with computing device 1200. In some cases, user interface component(s) 1225 include an audio device, such as an external speaker system, an external display device such as a display screen, an input device (e.g., a remote-control device interfaced with a user interface directly or through the I/O controller), or a combination thereof. In some cases, user interface component(s) 1225 include a GUI, such as the one described with reference to FIG. 2.

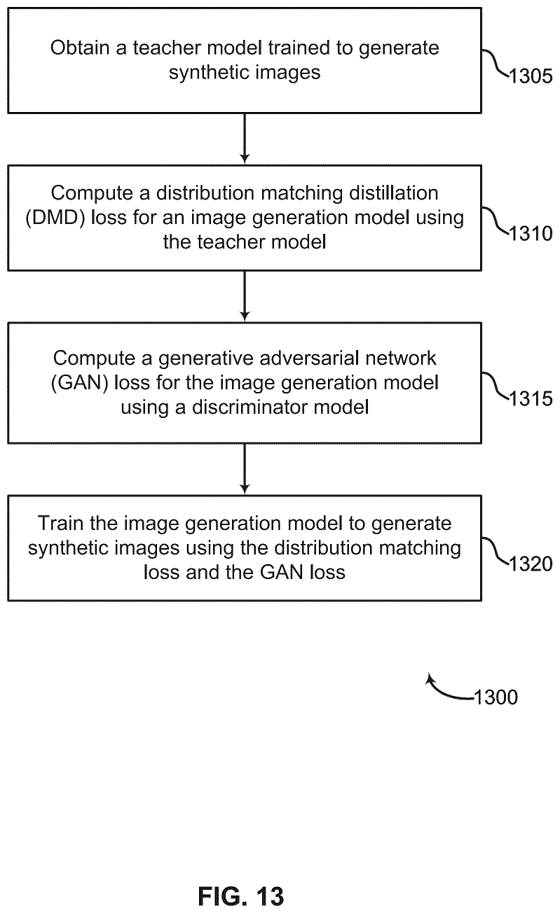

FIG. 13 shows an example of a method 1300 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the system obtains a teacher model trained to generate synthetic images. The teacher model may include a pre-trained diffusion model, such as a diffusion transformer (DiT), that has been trained on a large dataset to produce high-quality synthetic images through a multi-step denoising process. The teacher model is used as a reference for knowledge distillation, and provides target distributions and score functions that guide the training of a more efficient few-step image generation model. In some cases, the operations of this step refer to, or may be performed by, an image processing apparatus as described with reference to FIG. 2.

At operation 1310, the system computes a distribution matching distillation (DIMD) loss for an image generation model using the teacher model. The DIMD loss minimizes the Kullback-Leibler (KL) divergence between the distribution produced by the teacher model and a “fake” distribution generated by a jointly-trained auxiliary model, e.g. as shown in FIG. 8. The system computes a gradient term by combining scores from both the teacher model and the auxiliary model, where the scores represent gradients of log probability densities that guide the denoising process toward realistic data samples. In some cases, the operations of this step refer to, or may be performed by, a training component as described with reference to FIG. 2.

At operation 1315, the system computes a generative adversarial network (GAN) loss for the image generation model using a discriminator model, wherein the discriminator model classifies an output of the image generation model. The discriminator model, such as discriminator model 855 in FIG. 8, distinguishes between real images and synthetic outputs from the image generation model to provide an adversarial training signal. This GAN loss enables the image generation model to potentially surpass the teacher model in sample quality by addressing approximation errors in the score functions and preventing mode collapse. In some cases, the operations of this step refer to, or may be performed by, the training component as described with reference to FIG. 2.

At operation 1320, the system trains the image generation model to generate synthetic images using the distribution matching loss and the GAN loss. The training process may alternate between updating different components of the pipeline, such as training the image generation model using the gradient term and GAN loss for N iterations, then training the auxiliary model and discriminator for M iterations to ensure stable convergence. The combination of distribution matching distillation with adversarial learning provides complementary training signals that guide the image generation model toward producing high-quality, realistic outputs while maintaining computational efficiency during inference. In some cases, the operations of this step refer to, or may be performed by, the training component as described with reference to FIG. 2.

Accordingly, the present disclosure includes the following aspects.

A method for image generation is described. One or more aspects of the method include obtaining a teacher model trained to generate synthetic images; computing a distribution matching loss for the image generation model using the teacher model; computing a GAN loss for the image generation model using a discriminator model, wherein the discriminator model classifies an output of the image generation model; and training the image generation model to generate synthetic images using the distribution matching loss and the GAN loss.

Some examples of the method, apparatus, non-transitory computer readable medium, and system further include computing a first score function for an image generation model using the teacher model. Some examples further include computing a second score function for the image generation model using an auxiliary model, wherein the distribution matching loss is based on a difference between the first score function and the second score function.

Some examples of the method, apparatus, non-transitory computer readable medium, and system further include computing a Kullback-Leibler (KL) divergence based on the first score function and the second score function.

Some examples of the method, apparatus, non-transitory computer readable medium, and system further include computing an ODE matching loss, wherein the image generation model is trained based on the ODE matching loss.

In some aspects, the image generation model comprises a U-Net diffusion transformer (UDiT).

A method for image generation is described. One or more aspects of the method include obtaining an input prompt; generating, using a teacher model, an intermediate denoising output based on the input prompt; and generating, using an image generation model, a synthetic image based on the intermediate denoising output.

In some aspects, the intermediate denoising output is generated using a first denoising phase including a first set of denoising timesteps, and the synthetic image is generated using a second denoising phase including a second set of denoising timesteps following the first set of denoising timesteps.

Some examples of the method, apparatus, non-transitory computer readable medium, and system further include computing a distribution matching loss for the image generation model using the teacher model, wherein the image generation model is trained using the distribution matching loss.

Some examples of the method, apparatus, non-transitory computer readable medium, and system further include computing a GAN loss for the image generation model using a discriminator model, wherein the image generation model is trained using the GAN loss.

Some examples of the method, apparatus, non-transitory computer readable medium, and system further include computing an ODE matching loss, wherein the image generation model is trained using the ODE matching loss.

In some aspects, the image generation model comprises a U-Net diffusion transformer (UDiT).

A method for image generation is described. One or more aspects of the method include obtaining an input prompt; generating, using a first transformer block of an image generation model, a first set of intermediate tokens having a first patch size based on the input prompt; generating, using a second transformer block of the image generation model, a second set of intermediate tokens having a second patch size based on the first set of intermediate tokens; and generating, using the image generation model, a synthetic image based on the second set of intermediate tokens.

Some examples of the method, apparatus, non-transitory computer readable medium, and system further include obtaining a set of noise tokens having the first patch size, wherein the first set of intermediate tokens are generated based on the set of noise tokens.

Some examples of the method, apparatus, non-transitory computer readable medium, and system further include generating a set of conditioning tokens, wherein the first set of intermediate tokens are generated based on the set of conditioning tokens.

Some examples of the method, apparatus, non-transitory computer readable medium, and system further include generating, using a third transformer block of the image generation model, a third set of intermediate tokens having the first patch size based on the second set of intermediate tokens, wherein the synthetic image is generated based on the third set of intermediate tokens.

Some examples of the method, apparatus, non-transitory computer readable medium, and system further include providing the first set of intermediate tokens to the third transformer block via a skip connection.

Some examples of the method, apparatus, non-transitory computer readable medium, and system further include compressing the first set of intermediate tokens to obtain a set of compressed tokens having the second patch size, wherein the second set of intermediate tokens are based on the set of compressed tokens.

In some aspects, the second set of intermediate tokens comprises a higher number of embedding dimensions than the first set of intermediate tokens.

In some aspects, the second set of intermediate tokens comprises fewer tokens that the first set of intermediate tokens.

In some aspects, the image generation model comprises a U-Net diffusion transformer (UDiT).

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method of training a machine learning model, the method comprising:
obtaining a teacher model trained to generate synthetic images;
computing a distribution matching distillation (DMD) loss for an image generation model using the teacher model;
computing a generative adversarial network (GAN) loss for the image generation model using a discriminator model, wherein the discriminator model classifies an output of the image generation model; and
training the image generation model to generate synthetic images using the distribution matching loss and the GAN loss.

2. The method of claim 1, wherein computing the distribution matching loss comprises:
computing a first score function for an image generation model using the teacher model; and
computing a second score function for the image generation model using an auxiliary model, wherein the DMD loss is based on a difference between the first score function and the second score function.

3. The method of claim 2, further comprising:
computing a Kullback-Leibler (KL) divergence based on the first score function and the second score function.

4. The method of claim 2, wherein:
the auxiliary model is trained using the GAN loss.

5. The method of claim 1, further comprising:
computing an ODE matching loss, wherein the image generation model is trained based on the ODE matching loss.

6. The method of claim 1, wherein:
the teacher model is trained based on a first number of diffusion steps, and wherein the image generation model is trained to perform denoising using a second number of diffusion steps that is less than the first number of diffusion steps.

7. The method of claim 1, further comprising:
generating, using the image generation model, a synthetic image based on an intermediate denoising output from the teacher model.

8. A non-transitory computer readable medium storing code, the code comprising instructions that, when executed by at least one processor, cause the at least one processor to perform operations comprising:
obtaining an input prompt;
generating, using a teacher model, an intermediate denoising output based on the input prompt;
generating, using an image generation model, a synthetic image based on the intermediate denoising output, wherein the image generation model is trained based on the teacher model using a distribution matching distillation (DMD) loss.

9. The non-transitory computer readable medium of claim 8, the code further comprising instructions that, when executed by the at least one processor, cause the at least one processor to perform operations comprising:
computing a generative adversarial network (GAN) loss for the image generation model using a discriminator model, wherein the synthetic image is generated based on the GAN loss.

10. The non-transitory computer readable medium of claim 8, wherein:
the intermediate denoising output is generated using a first denoising phase including a first set of denoising timesteps, and the synthetic image is generated using a second denoising phase including a second set of denoising timesteps following the first set of denoising timesteps.

11. The non-transitory computer readable medium of claim 8, the code further comprising instructions that, when executed by the at least one processor, cause the at least one processor to perform operations comprising:
computing an ODE matching loss, wherein the image generation model is trained using the ODE matching loss.

12. The non-transitory computer readable medium of claim 8, wherein:
the teacher model is trained based on a first number of diffusion steps, and wherein the image generation model performs the denoising using a second number of diffusion steps that is less than the first number of diffusion steps.

13. The non-transitory computer readable medium of claim 8, the code further comprising instructions that, when executed by the at least one processor, cause the at least one processor to perform operations comprising:
computing a first score function for an image generation model using the teacher model; and
computing a second score function for the image generation model using an auxiliary model, wherein the distribution matching loss is based on a difference between the first score function and the second score function.

14. The non-transitory computer readable medium of claim 13, the code further comprising instructions that, when executed by the at least one processor, cause the at least one processor to perform operations comprising:
computing a Kullback-Leibler (KL) divergence based on the first score function and the second score function.

15. A system comprising:
a memory component; and
a processing device coupled to the memory component, the processing device configured to perform operations comprising:
obtaining an input prompt;
generating, using a teacher model, an intermediate denoising output based on the input prompt;
generating, using an image generation model, a synthetic image based on the intermediate denoising output, wherein the image generation model is trained based on the teacher model using a distribution matching distillation (DMD) loss.

16. The system of claim 15, wherein the teacher model is further configured to:
compute a first score based on an output from the image generation model.

17. The system of claim 16, further comprising:
an auxiliary model configured to compute a second score based on the output from the image generation model.

18. The system of claim 17, wherein:
the DMD loss is based on a difference between a first score function and a second score function.

19. The system of claim 15, further comprising:
a discriminator model configured to classify an output of the image generation model, wherein the image generation model is trained based on the classification.

20. The system of claim 15, wherein:
the image generation model comprises a U-Net diffusion transformer (UDiT) model.
